(19) United States
(12) Patent Application Publication
(10) Pub. No.: US 2018/0318870 A1
(43) Pub. Date: Nov. 8, 2018

(54) CAULKING GUN

(71) Applicant: SIANG SYUAN FU ENTERPRISE CO., LTD., Changhua County (TW)

(72) Inventor: HUNG-CHIH HUNG, Changhua County (TW)

(21) Appl. No.: 15/970,060

(22) Filed: May 3, 2018

(30) Foreign Application Priority Data
May 5, 2017 (TW) 106114929

(51) Int. Cl. B05C 17/005; B05C 17/01

(52) U.S. Cl. CPC B05C 17/00506; B05C 17/00593; B05C 17/00583; B05C 17/01

(57) ABSTRACT

A caulking gun is provided, including a gun body; a carrier, rotatably assembled to the gun body, the carrier having a receiving room and a through opening which is communicated axially with the receiving room, the receiving room having an opening which is open radially outwardly, the receiving room being adapted for receiving a caulk cartridge; a first sleeve, disengageably attached to the carrier, at least part of the first sleeve overlapping the opening radially; a pushing rod, movably assembled to the gun body, and extending through the through opening and into the receiving room; wherein the first sleeve is disposed around an outer lateral side of the carrier, and the first sleeve is transversely across the opening side to side.

### BACKGROUND OF THE INVENTION

### Field of the Invention

The present invention relates to a caulking gun.

### Description of the Prior Art

Generally, a caulking gun is convenient to fix a gap of a corner of a wall, and a crevice of a joint of two members.

A conventional caulking gun, mainly, includes a gun body, a carrier and a pushing rod. The carrier is assembled to the gun body, and has an annular flange, the carrier is adapted for assembling the caulk cartridge therewithin, and the annular flange can prevent the caulk cartridge from being disassembled radially out of the carrier. The pushing rod is disposed movably to the gun body and extends into the carrier. However, the carrier of the conventional caulking gun is fixed to the gun body, specifically, the carrier cannot be rotatably relative to the gun body, so that the conventional caulking gun cannot be adjusted to any angles for working needs, for example a variety of angular corners. Besides, the annular flange and the carrier are integrally formed of one piece. In general, the carrier is made of metal material. Thus, the carrier is too thick and too hard to fold.

The present invention is, therefore, arisen to obviate or at least mitigate the above mentioned disadvantages.

### SUMMARY OF THE INVENTION

An object of the present invention is to provide a caulking gun, which is angular adjustable and easy to produce.

To achieve the above and other objects, a caulking gun is provided, including: a gun body; a carrier, rotatably assembled to the gun body, the carrier having a receiving room and a through opening which is communicated with the receiving room, the receiving room having an opening which is open radially outwardly, the receiving room being adapted for receiving a caulk cartridge; a first sleeve, disengageably attached to the carrier, at least part of the first sleeve overlapping the opening radially; a pushing rod, movably assembled to the gun body, and extending through the through opening and into the receiving room; wherein the first sleeve is disposed around an outer lateral side of the carrier, and the first sleeve is transversely across the opening side to side.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a caulking gun according to a preferred embodiment of the present invention;

FIG. 2 is a breakdown drawing of the preferable embodiment of the present invention;

FIG. 3 is an enlarged perspective view of a second sleeve of the preferable embodiment of the present invention;

FIG. 4 is a cross-sectional view of the preferable embodiment of the present invention;

FIG. 5 is a partially-enlarged view of FIG. 4; and

FIG. 6 is another partially-enlarged view of FIG. 4.

### DETAILED DESCRIPTION OF THE PREFERRED EMBODIMENTS

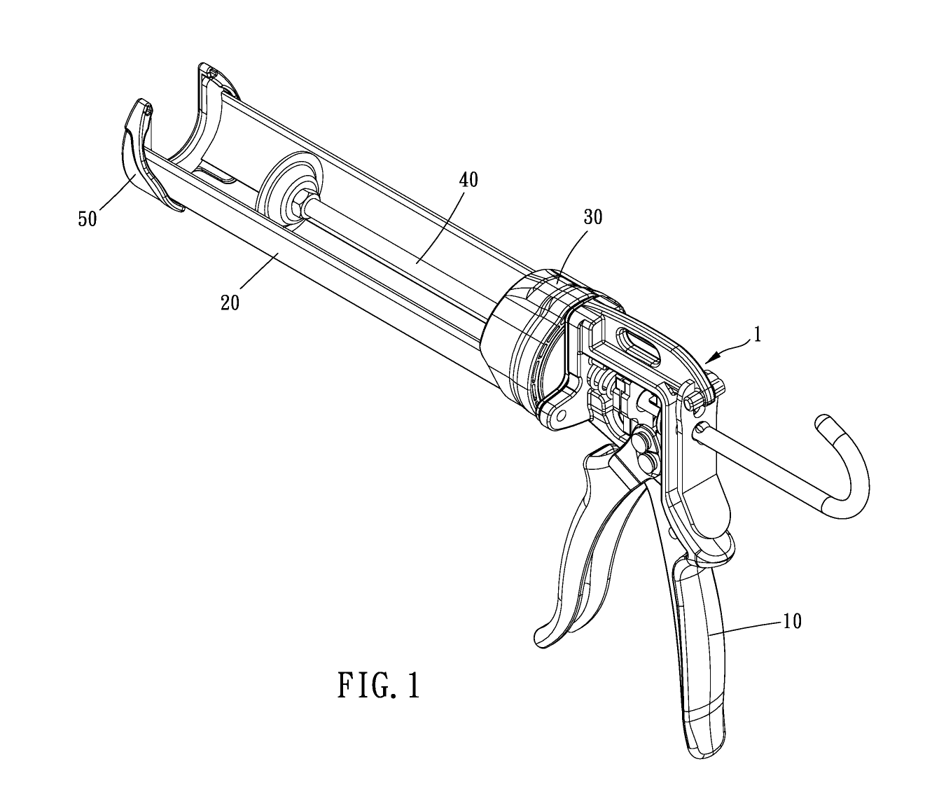

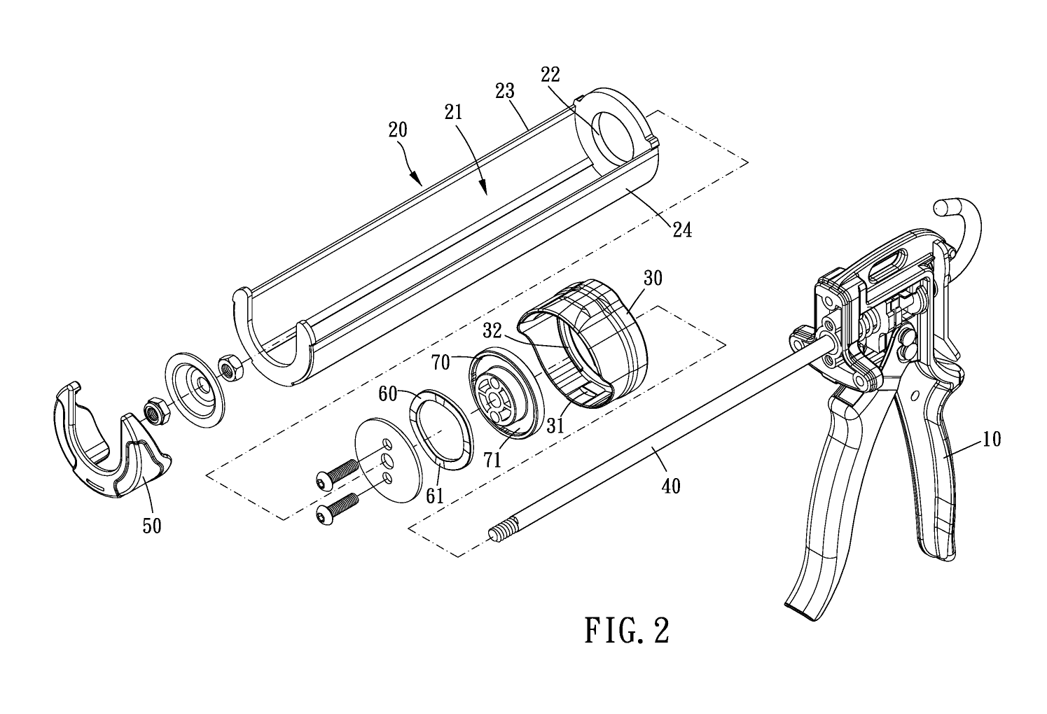

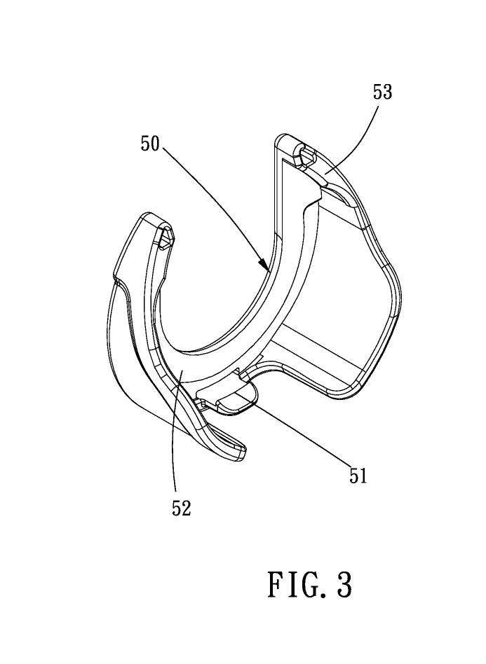

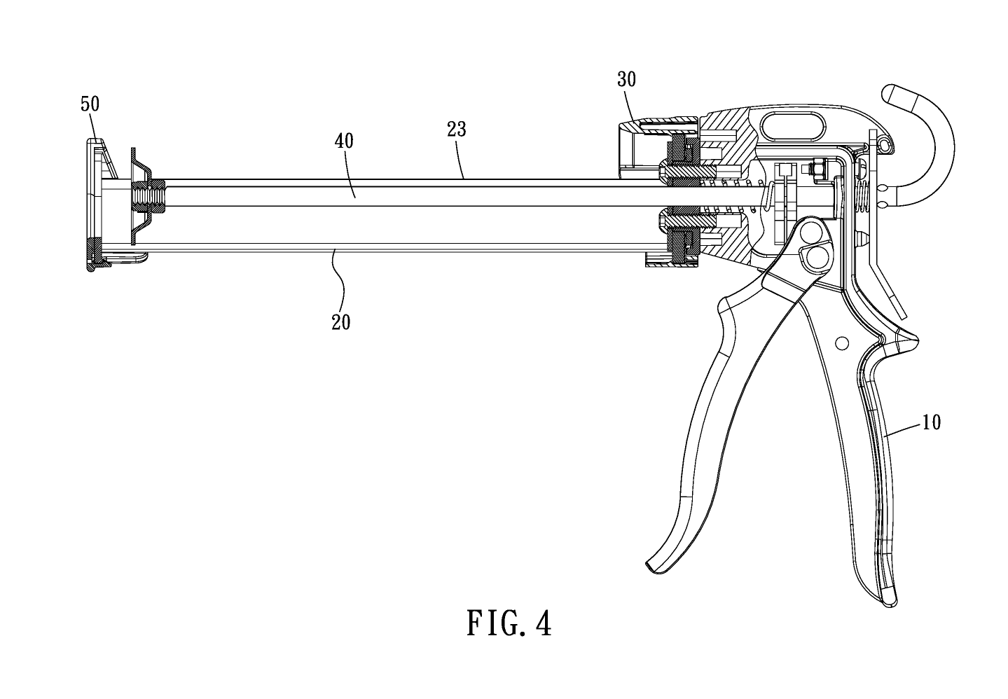

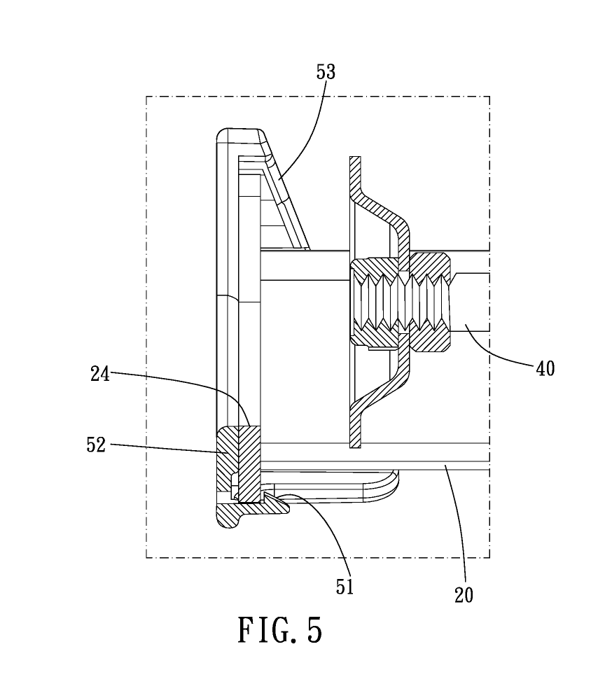

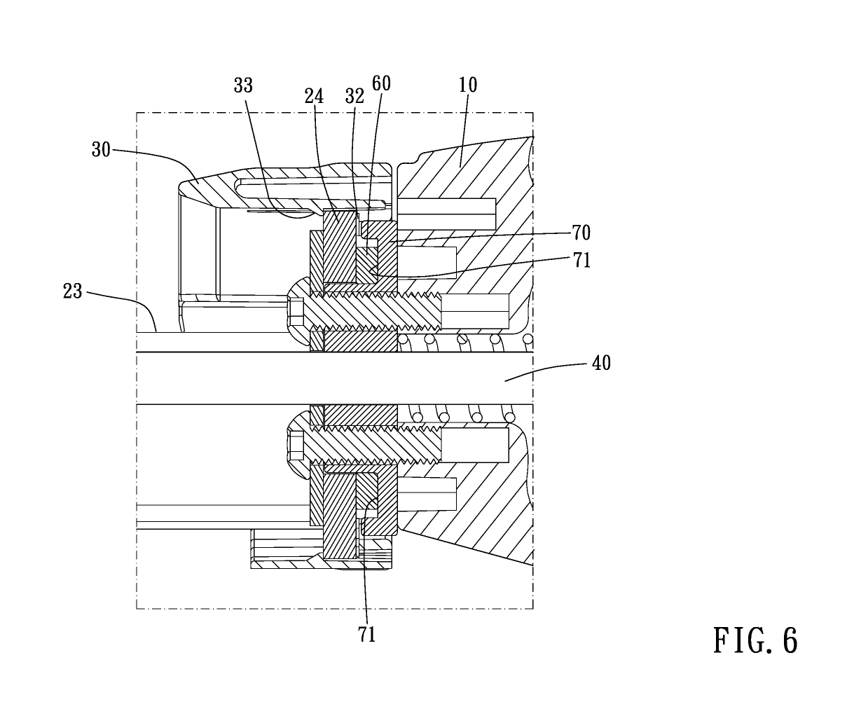

FIGS. 1 to 6 show a caulking gun 1 according to a preferred embodiment of the present invention. The caulking gun 1 includes a gun body 10, a carrier 20, a first sleeve 30 and a pushing rod 40.

The carrier 20 is rotatably assembled to the gun body 10, the carrier 20 has a receiving room 21 and a through opening 22 which is communicated axially with the receiving room 21, the through opening 22 can be half open, partial open and fully open. In this embodiment, the through opening 22 is a through hole. The receiving room 21 has an opening 23 which is open radially outwardly, and the receiving room 21 is adapted for receiving a caulk cartridge. The first sleeve 30 is disengageably attached to the carrier 20, and at least part of the first sleeve 30 overlaps the opening 23 radially. In other embodiment, the first sleeve and the opening can be fully overlapping radially. The pushing rod 40 is movably assembled to the gun body 10, and extends through the through opening 22 and into the receiving room 21. Thus, the present invention is angular adjustable and easy to produce. Besides, the first sleeve 30 can prevent the caulk cartridge from being disengaged from the carrier 20 easily. Wherein the first sleeve 30 is disposed around an outer lateral side of the carrier 20, and the first sleeve 30 is transversely across the opening 23 side to side, so as to strong a strength of the caulking gun 1, and to be assembled to the carrier 20 and also can support the carrier 20. More specifically, the outer lateral side is arranged in a radial side of the carrier 20.

Specifically, the first sleeve 30 can be fully or partially disposed around an outer periphery of the carrier 20 so that the carrier 20 is not easily to be disengaged from the first sleeve 30. In this embodiment, the carrier 20 and the first sleeve 30 are made of different materials, and the first sleeve 30 is made of deformable material. Thus, the carrier 20 and the first sleeve 30 can be produced independently, and the first sleeve 30 can be easily folded and molded. As a result, the caulking gun 1 is easily to produce. The carrier 20 has a lateral wall 24, and the through opening 22 is arranged on the lateral wall 24. The first sleeve 30 has at least one first engaging portion 31 and at least one second engaging portion 32 which are respectively engaged with two opposite sides of the lateral wall 24. In this embodiment, a number of the at least one first engaging portion 31 and a number of the at least one second engaging portion 32 are respectively plural. Each of the plurality of first engaging portions 31 and each of the plurality of second engaging portions 32 are arranged alternately around an axial direction of the first sleeve 30, so as to connect fixably the first sleeve 30 with the carrier 20. Specifically, the at least one first engaging portion 31 and the at least one second engaging portion 32 are arranged axially on the first sleeve 30, so as to prevent the carrier 20 from sliding relatively to the first sleeve 30 in the axial direction.

Besides, the at least one first engaging portion 31 is resilient. Thus, the at least one first engaging portion 31 can be elastic deformed and elastic recover, so as to assemble the first sleeve 30 to the carrier 20 easily.

Preferably, the at least one first engaging portion 31 has a guiding slant wall 33, the guiding slant wall 33 extends gradually inwardly in a direction which is from a front end of the carrier 20 to the gun body 10. Thus, the first sleeve 30 can be smoothly engaged with the carrier 20.

The caulking gun 1 further includes a second sleeve 50. The second sleeve 50 is disengageably connected with the carrier 20, and at least part of the second sleeve 50 overlaps the carrier 20 radially, and also can be fully overlapped, so as to prevent the caulk cartridge from being disengaged from the carrier 20. In this embodiment, the second sleeve 50 has an elastic engaging member 51 and a wall 52. The elastic engaging member 51 can be elastic deformed and elastic recover. The elastic engaging member 51 and the wall 52 respectively abut two opposite sides of the lateral wall 24, so as to easily disengage the second sleeve 50 from the carrier 20 and assemble the second sleeve 50 to the carrier 20. In this embodiment, the second sleeve 50 is disposed on a front end of the carrier 20, so as to easily assemble and disassemble the caulk cartridge to the carrier 20.

The first sleeve 30 and the second sleeve 50 described above, can be connected with the carrier in a connection manner of screw, lock, engagement, male-female thread relationship, etc.

The second sleeve 50 further includes two position-limited walls 53 which are spaced in intervals. The two position-limited walls 53 and the wall 52 are respectively abutted against the two opposite sides of the lateral wall 24, so as to prevent the second sleeve 50 from sliding relatively to the carrier 20.

The caulking gun 1 further includes a spacing portion 60 and a seat portion 70. The spacing portion 60 and the seat portion 70 are disposed between an end wall of the carrier 20 which is arranged in an axial direction of the carrier 20 and the gun body 10. The seat portion 70 has a support wall 71, the spacing portion 60 has at least one convex portion 61 which is connected abutly with support wall 71. The at least one convex portion 61 abuts rotatably between the end wall of the carrier 20 which is arranged in the axial direction and the gun body 10. Preferably, a number of the at least one convex portion 61 is three, the at least one convex portion 61 may be a single extending projection which is, for example, arched, annular, elongated, polygonal or the like. The spacing portion 60 may be polygonal or in any shape. The convex portions 61 are preferably elastically deformable (including elastically deformable in material or in assembled-structure). In this embodiment, the seat portion 70 is a plate body which is non-integrally formed as a part of the gun body 10. The spacing portion 60 is a non-integrally formed as a part of the carrier 20. The spacing portion 60 is a waved-ring plate. In other embodiment, the spacing portion may be integral with the gun body and may be made of/from metal, plastic, silicon, rubber or a combination thereof. Whereby, the carrier 20 can be rotated orientationally relatively to the gun body 10 and frictionally positioned for adjusting the angle. Moreover, the carrier 20 and the gun body 10 can be stably connected with each other without rocking through adjusting.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A caulking gun, including:
a gun body;
a carrier, rotatably assembled to the gun body, the carrier having a receiving room and a through opening which is communicated axially with the receiving room, the receiving room having an opening which is open radially outwardly, the receiving room being adapted for receiving a caulk cartridge;
a first sleeve, disengageably attached to the carrier, at least part of the first sleeve overlapping the opening radially;
a pushing rod, movably assembled to the gun body, and extending through the through opening and into the receiving room;
wherein the first sleeve is disposed around an outer lateral side of the carrier, and the first sleeve is transversely across the opening side to side.

2. The caulking gun of claim 1, wherein the carrier has a lateral wall, the through opening is arranged on the lateral wall, the first sleeve has at least one first engaging portion and at least one second engaging portion which are respectively engaged with two opposite sides of the lateral wall, and the at least one first engaging portion is resilient.

3. The caulking gun of claim 2, wherein the at least one first engaging portion and the at least one second engaging portion are arranged axially on the first sleeve.

4. The caulking gun of claim 2, wherein the at least one first engaging portion has a guiding slant wall, and the guiding slant wall extends gradually inwardly in a direction which is from a front end of the carrier to the gun body.

5. The caulking gun of claim 2, wherein the at least one first engaging portion and the at least one second engaging portion are arranged alternately around an axial direction of the first sleeve.

6. The caulking gun of claim 1, wherein the carrier and the first sleeve are made of different materials.

7. The caulking gun of claim 1, further including a second sleeve, the second sleeve disengageably connected with the carrier, and at least part of the second sleeve overlapping the carrier radially.

8. The caulking gun of claim 2, wherein the second sleeve has an elastic engaging member and a wall, the elastic engaging member and the wall respectively abut two opposite sides of the lateral wall, and the second sleeve is disposed on a front end of the carrier.

9. The caulking gun of claim 1, further including a spacing portion and a seat portion, the spacing portion and the seat portion disposed between an end wall of the carrier which is arranged in an axial direction of the carrier and the gun bod, the seat portion having a support wall, the spacing portion having at least one convex portion which is abutted against the support wall, and the at least one convex portion abuts rotatably between the end wall of the carrier which is arranged in the axial direction and the gun body.

10. The caulking gun of claim 3, wherein a number of the at least one first engaging portion and a number of the at least one second engaging portion are respectively plural; each of the plurality of first engaging portions and each of the plurality of second engaging portions are arranged alternately around an axial direction of the first sleeve; each of the plurality first engaging portions has a guiding slant wall, the guiding slant wall extends gradually inwardly in a direction which is from a front end of the carrier to the gun body; the carrier and the first sleeve are made of different materials; the caulking gun further includes a second sleeve, the second sleeve is disengageably connected with the carrier, and at least part of the second sleeve overlaps the carrier radially; the second sleeve has an elastic engaging member and a wall, the elastic engaging member and the wall respectively abut two opposite sides of the lateral wall, and the second sleeve is disposed on a front end of the carrier; the second sleeve further includes two position-limited walls which are spaced in intervals, the two position-limited walls and the wall are respectively abutted against the two opposite sides of the lateral wall which are arranged in the axial direction; wherein the first sleeve is made of deformable material; the caulking gun further includes a spacing portion and a seat portion, the spacing portion and the seat portion are disposed between an end wall of the carrier which is arranged in an axial direction of the carrier and the gun bod, the seat portion has a support wall, the spacing portion has at least one convex portion which is abutted against the support wall, and the at least one convex portion abuts rotatably between the end wall of the carrier which is arranged in the axial direction and the gun body.
